(19) United States
(12) Patent Application Publication
(10) Pub. No.: US 2012/0133152 A1
(43) Pub. Date: May 31, 2012

(54) SYSTEMS AND METHODS FOR COOLING ELECTRICAL COMPONENTS OF WIND TURBINES

(76) Inventors: Robert Gregory Wagoner, Roanoke, VA (US); Allen Michael Ritter, Roanoke, VA (US); Steven Wade Sutherland, Roanoke, VA (US)

(21) Appl. No.: 13/306,660

(22) Filed: Nov. 29, 2011

(51) Int. Cl. F03D 11/00

(52) U.S. Cl. 290/1 B

(57) ABSTRACT

A cooling system for use in cooling an electrical component of a wind turbine is described herein. The cooling system includes a first heat exchange assembly that is coupled to the electrical component. The first heat exchange assembly is configured to transfer heat from the electrical component to a cooling fluid. A fluid distribution assembly is coupled to the first heat exchange assembly for selectively channeling the cooling fluid to the first heat exchange assembly. The fluid distribution assembly is configured to adjust a flowrate of the cooling fluid being channeled to the first heat exchange assembly to adjust a temperature of the component.

### BACKGROUND OF THE INVENTION

The subject matter described herein relates generally to wind turbines, and more specifically, to systems and methods for cooling electrical components of wind turbines.

At least some known wind turbine towers include a nacelle fixed atop a tower. The nacelle includes a rotor assembly coupled to a generator through a rotor shaft. In known rotor assemblies, a plurality of blades extend from a rotor. The blades are oriented such that wind passing over the blades turns the rotor and rotates the shaft, thereby driving the generator to generate electricity.

In at least some known wind turbines, various wind turbine components are positioned within the tower and/or the nacelle. During operation of known wind turbines, the wind turbine components generate heat which increases a temperature of the tower and/or the nacelle. As the temperature of the tower and/or the nacelle is increased, the operation of the wind turbine components may be adversely affected. In addition, as the operating temperature of wind turbine electrical components increases, an operational reliability of the electrical components is reduced. Moreover, over time, the increased operating temperature may cause damage and/or failure of the electrical components, which results in an increase in the cost of operating and maintaining wind turbines.

### BRIEF DESCRIPTION OF THE INVENTION

In one embodiment, a cooling system for use in cooling an electrical component of a wind turbine is provided. The cooling system includes a first heat exchange assembly coupled to the electrical component. The first heat exchange assembly is configured to transfer heat from the electrical component to a cooling fluid. A fluid distribution assembly is coupled to the first heat exchange assembly for selectively channeling the cooling fluid to the first heat exchange assembly. The fluid distribution assembly is configured to adjust a flowrate of the cooling fluid being channeled to the first heat exchange assembly to adjust a temperature of the component.

In another embodiment, a wind turbine is provided. The wind turbine includes a nacelle, a generator positioned within the nacelle, and a cooling system coupled to an electrical component of the generator for adjusting a temperature of the electrical component. The cooling system includes a first heat exchange assembly that is coupled to the electrical component. The first heat exchange assembly is configured to transfer heat from the electrical component to a cooling fluid. A fluid distribution assembly is coupled to the first heat exchange assembly for selectively channeling the cooling fluid to the first heat exchange assembly. The fluid distribution assembly is configured to selectively adjust a flowrate of the cooling fluid to adjust a temperature of the electrical component.

In yet another embodiment, a method of adjusting a temperature of an electrical component of a wind turbine is provided. The method includes transmitting, from a sensor to a controller, a signal indicative of a temperature of an electrical component. A flow of cooling fluid is channeled from a fluid distribution assembly to a first heat exchange assembly that is coupled to the electrical component based at least in part on the sensed electrical component temperature to facilitate reducing a temperature of the electrical component. A flowrate of the cooling fluid channeled from the fluid distribution assembly to the electrical component is adjusted based at least in part on the sensed electrical component temperature.

### BRIEF DESCRIPTION OF THE DRAWINGS

FIG. 1 is a perspective view of an exemplary wind turbine.

FIG. 2 is schematic top view of the wind turbine shown in FIG. 1 including an exemplary cooling system.

FIGS. 3-5 are sectional views of alternative embodiments of the cooling system shown in FIG. 2.

FIG. 6 is a flow chart of an exemplary method that may be used in adjusting a temperature of electrical components of the wind turbine shown in FIG. 1.

### DETAILED DESCRIPTION OF THE INVENTION

The exemplary methods and systems described herein overcome at least some disadvantages of known cooling systems by providing a cooling system that includes a variable speed fluid distribution assembly to facilitate cooling electrical components of wind turbines. Moreover, the embodiments described herein include a fluid distribution assembly configured to adjust a flowrate of cooling fluid being channeled to the electrical components to maintain an operating temperature of the electrical components within a predefined range of operating temperature to increase an operational reliability of the electrical components. In addition, by varying the flowrate of cooling fluid to the electrical components, the components may be operated at a higher power capability. Moreover, by operating the fluid distribution assembly to adjust the flowrate of cooling fluid, the power consumption of the cooling system can be optimized. As such, the duration and frequency of operating the cooling system is facilitated to be reduced, which reduces the amount of power required to operate the cooling system and facilitates reducing the cost of cooling known wind turbine electrical components.

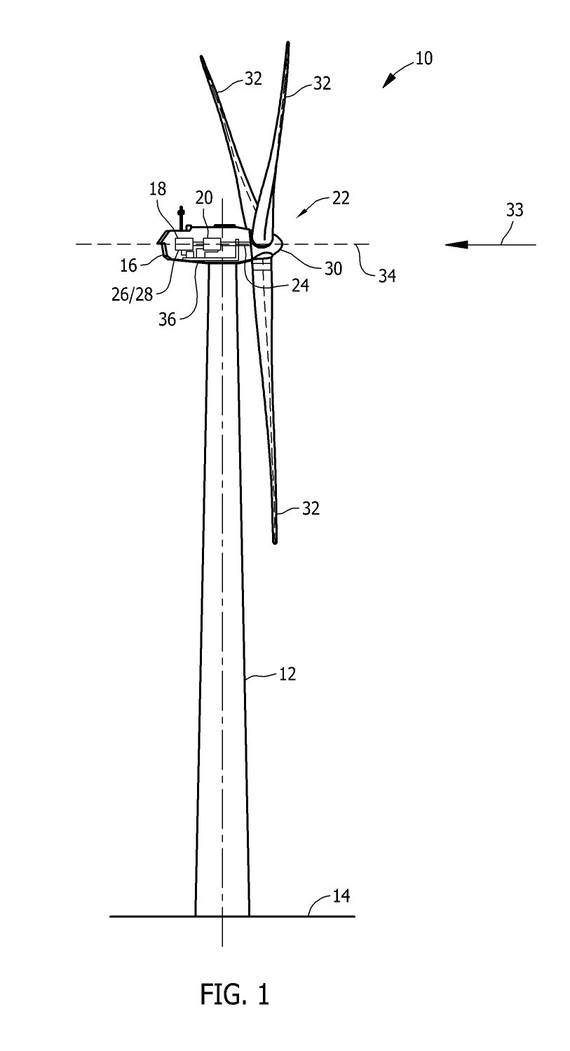

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support surface 14, a nacelle 16 mounted on tower 12, a generator 18 that is positioned within nacelle 16, a gearbox 20 coupled to generator 18, and a rotor 22 that is rotatably coupled to gearbox 20 with a drive shaft 24. Generator 18 includes a plurality of electrical components 26 such as, for example, a power converter 28 to facilitate converting mechanical energy into electrical energy. Rotor 22 includes a rotatable hub 30 and at least one rotor blade 32 that is coupled to and extends outwardly from hub 30. Alternatively, wind turbine 10 does not include gearbox 20, such that rotor 22 is coupled to generator 18 via drive shaft 24.

In the exemplary embodiment, rotor 22 includes three rotor blades 32. In an alternative embodiment, rotor 22 includes more or less than three rotor blades 32. Rotor blades 32 are spaced about hub 30 to facilitate rotating rotor 22 to enable kinetic energy to be transferred from the wind into usable mechanical energy, and subsequently, electrical energy. In the exemplary embodiment, each rotor blade 32 has a length ranging from about 30 meters (m) (99 feet (ft)) to about 120 m (394 ft). Alternatively, rotor blades 32 may have any suitable length that enables wind turbine 10 to function as described herein. For example, other non-limiting examples of rotor blade lengths include 10 m or less, 20 m, 37 m, or a length that is greater than 120 m.

During operation of wind turbine 10, as wind, represented by arrow 33, interacts with rotor blades 32, rotor 22 is rotated causing a rotation of drive shaft 24 about a centerline axis 34. A rotation of drive shaft 24 rotatably drives gearbox 20 that subsequently drives generator 18 to facilitate production of electrical power by generator 18. Over time, an operating temperature of generator electrical components 26 may increase, which may reduce an operating performance of generator 18 and/or may cause damage to generator electrical components 26.

In the exemplary embodiment, wind turbine 10 includes a cooling system 36 that is coupled to generator 18 to facilitate adjusting a temperature of generator 18. More specifically, cooling system 36 selectively channels a cooling fluid to generator electrical components 26 to facilitate reducing a temperature of electrical components 26 during operation of wind turbine 10. In the exemplary embodiment, cooling system 36 is configured to selectively adjust a flowrate of the cooling fluid being channeled to electrical components 26 to adjust a temperature of electrical components 26, and to adjust a power consumption of cooling system 36.

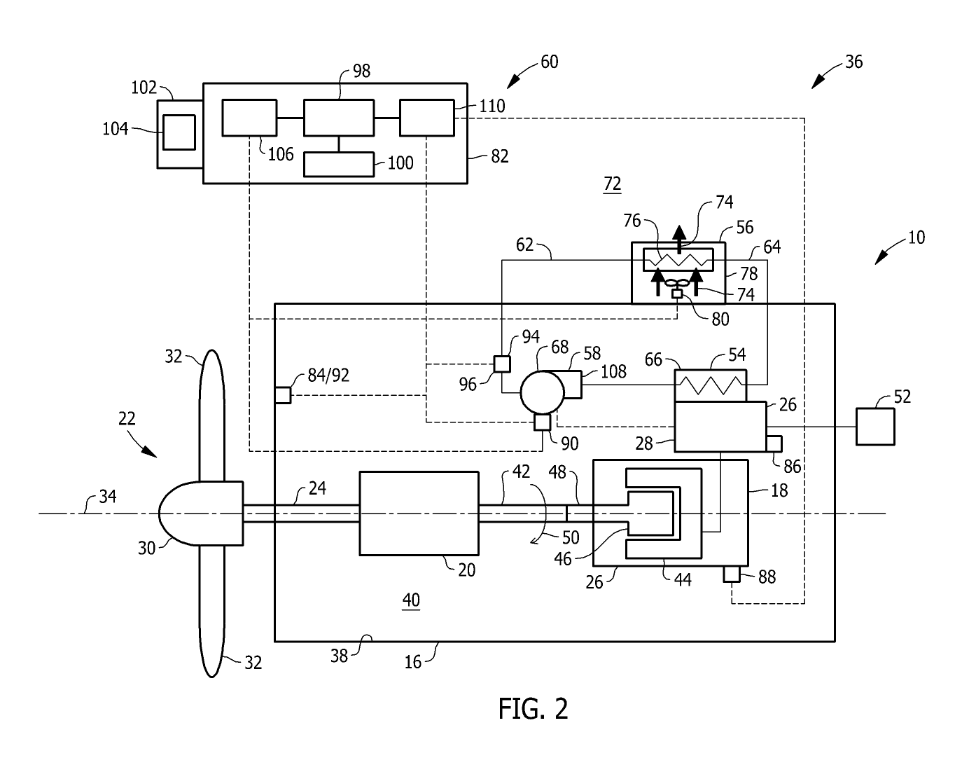

FIG. 2 is a schematic view of wind turbine 10. Identical components shown in FIG. 2 are labeled with the same reference numbers used in FIG. 1. In the exemplary embodiment, nacelle 16 includes an inner surface 38 that defines an interior volume 40 therein. Gearbox 20, generator 18, and at least a portion of drive shaft 24 are each positioned within interior volume 40. Drive shaft 24 extends between rotor 22 and gearbox 20. Hub 30 is coupled to drive shaft 24 such that a rotation of hub 30 about axis 34 facilitates rotating drive shaft 24 about axis 34. A high speed shaft 42 is coupled between gearbox 20 and generator 18 such that a rotation of drive shaft 24 rotatably drives gearbox 20 that subsequently drives high speed shaft 42. High speed shaft 42 rotatably drives generator 18 to facilitate production of electrical power by generator 18.

Generator 18 may include any suitable type of electrical generator, such as, but not limited to, a wound rotor induction generator, a double-fed induction generator (DFIG, also known as dual-fed asynchronous generators), a permanent magnet (PM) synchronous generator, an electrically-excited synchronous generator, and a switched reluctance generator. In the exemplary embodiment, generator 18 includes a stator 44 and a generator rotor 46 positioned adjacent stator 44 to define an air gap therebetween. Generator rotor 46 includes a generator shaft 48 coupled to high speed shaft 42 such that rotation of drive shaft 24 drives rotation of generator rotor 46. A torque of drive shaft 24, represented by arrow 50, drives generator rotor 46 to facilitate generating variable frequency AC electrical power from a rotation of drive shaft 24. Generator 18 imparts an air gap torque between generator rotor 46 and stator 44 that opposes torque 50 of drive shaft 24. Power converter 28 is coupled to generator rotor 46 and stator 44 for converting the variable frequency AC to a fixed frequency AC for delivery to an electrical load 52 such as, for example, a power grid coupled to generator 18. Power converter 28 is configured to adjust the air gap torque between generator rotor 46 and stator 44 by adjusting a power current and/or power frequency distributed to stator 44 and generator rotor 46. Power converter 28 may include a single frequency converter or a plurality of frequency converters that are configured to convert electricity generated by generator 18 to electricity suitable for delivery over the power grid.

In the exemplary embodiment, cooling system 36 includes a first heat exchange assembly 54, a second heat exchange assembly 56, a fluid distribution assembly 58, and a control system 60. A plurality of cooling fluid supply lines 62 are coupled between first heat exchange assembly 54, second heat exchange assembly 56, and fluid distribution assembly 58 such that a cooling circuit 64 is defined between first heat exchange assembly 54, second heat exchange assembly 56, and fluid distribution assembly 58. In the exemplary embodiment, cooling circuit 64 is a closed-loop system that channels a flow of cooling fluid between first heat exchange assembly 54, second heat exchange assembly 56, and fluid distribution assembly 58. In the exemplary embodiment, cooling circuit 64 is charged with a cooling fluid that includes a propylene glycol. Alternatively, the cooling fluid may include an ethylene glycol, an isopropyl alcohol based fluid, and/or any suitable fluid that enables cooling system 36 to function as described herein.

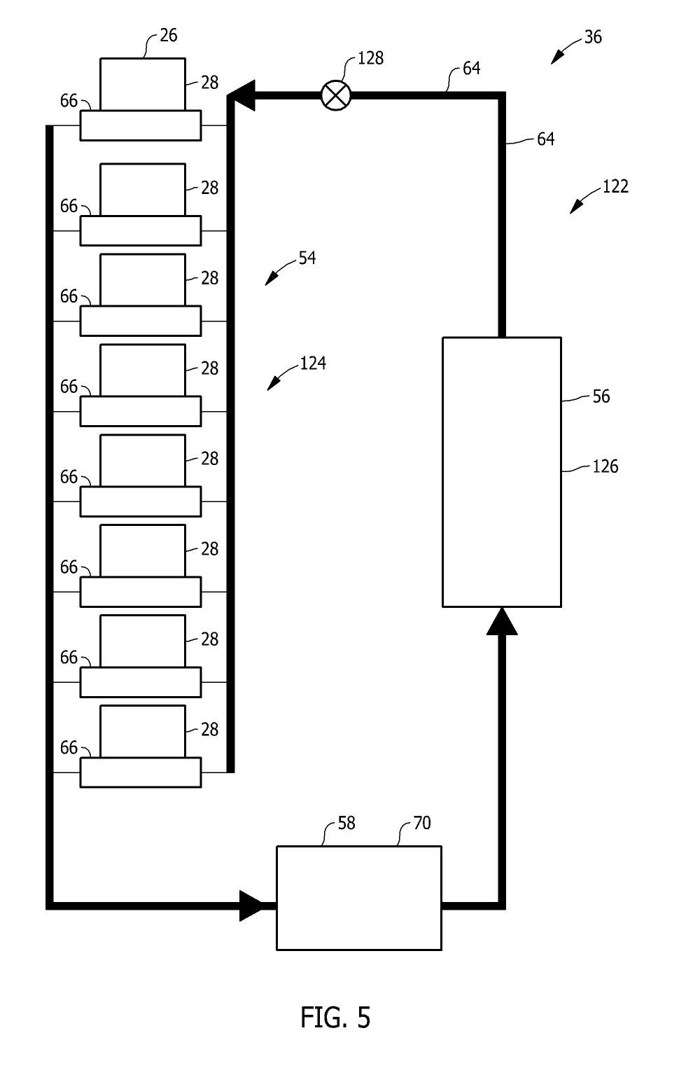

In the exemplary embodiment, first heat exchange assembly 54 is coupled to power converter 28, and is configured to transfer heat from power converter 28 to the cooling fluid. In one embodiment, first heat exchange assembly 54 includes a chiller plate 66 configured to receive cooling fluid therein, and to transfer heat from power converter 28 to the cooling fluid. In another embodiment, first heat exchange assembly 54 includes a plurality of chiller plates 66 (shown in FIG. 5) coupled to a plurality of electrical components 26 (shown in FIG. 5). Alternatively, first heat exchange assembly 54 may be any suitable heat exchange device that enables cooling system 36 to function as describe herein.

Fluid distribution assembly 58 is coupled in flow communication with first heat exchange assembly 54 for selectively channeling the cooling fluid to first heat exchange assembly 54 to facilitate adjusting a temperature of power converter 28. In the exemplary embodiment, fluid distribution assembly 58 is configured to selectively adjust a flowrate of the cooling fluid being channeled to first heat exchange assembly 54 to adjust a temperature of power converter 28. In the exemplary embodiment, fluid distribution assembly 58 includes a variable speed fluid pump 68 coupled to a power source such as, for example, power converter 28. In another embodiment, fluid distribution assembly 58 includes a variable speed compressor 70 (shown in FIG. 5). Fluid distribution assembly 58 is also configured to adjust a flowrate of the cooling fluid to facilitate selectively adjusting a power consumption of fluid distribution assembly 58.

Second heat exchange assembly 56 is coupled between first heat exchange assembly 54 and fluid distribution assembly 58. Second heat exchange assembly 56 is configured to receive heated cooling fluid from first heat exchange assembly 54, and to reduce a temperature of the cooling fluid by transferring heat from cooling fluid to air. More specifically, second heat exchange assembly 56 is in area 72, is in flow communication with ambient air 74, and is configured to channel a flow of ambient air 74 across the cooling fluid to transfer heat from the cooling fluid to ambient air 74. In the exemplary embodiment, second heat exchange assembly 56 includes a plurality of cooling lines 76 that are positioned within a casing 78. Cooling lines 76 channel cooling fluid through second heat exchange assembly 56. Casing 78 facilitates channeling ambient air 74 across an outer surface of each pipeline 76. Moreover, second heat exchange assembly 56 transfers heat from the cooling fluid flowing therethrough to ambient air 74 flowing past cooling lines 76. Second heat exchange assembly 56 also includes a fan 80 that channels air 74 across cooling lines 76 to facilitate reducing a temperature of the cooling fluid.

In the exemplary embodiment, second heat exchange assembly 56 is positioned external to nacelle 16 and reduces a temperature of the cooling fluid by transferring heat from the cooling fluid to ambient air 74. More specifically, second heat exchange assembly 56 is positioned in an area 72 defined external to nacelle 16, and is in flow communication with ambient air flowing past nacelle 16. By positioning second heat exchange assembly 56 external to nacelle 16, the heat generated by power converter 28 is transferred to ambient air external to nacelle 16, thus reducing a temperature within nacelle interior volume 40. In an alternative embodiment, second heat exchange assembly 56 is positioned within nacelle interior volume 40, such that second heat exchange assembly 56 is in flow communication with ambient air that is contained within nacelle interior volume 40.

Control system 60 is coupled in operative communication to fluid distribution assembly 58, first heat exchange assembly 54, and/or second heat exchange assembly 56 to operate cooling system 36 to facilitate adjusting a temperature of electrical component 26. Moreover, control system 60 is configured to operate fluid distribution assembly 58 such that power converter 28 operates within a predefined range of operating temperatures. More specifically, control system 60 operates fluid distribution assembly 58 to adjust a flowrate of cooling fluid being channeled through cooling system 36 to adjust a temperature of power converter 28.

In the exemplary embodiment, control system 60 includes a controller 82 that is coupled to one or more sensors 84. Each sensor 84 senses various parameters relative to the operation and environmental conditions of wind turbine 10, nacelle interior volume 40, cooling system 36, generator 18, and electrical components 26. Sensors 84 may include, but are not limited to only including, temperature sensors, flow sensors, fluid pressure sensors, power loading sensors, and/or any other sensors that sense various parameters relative to the condition of wind turbine 10, interior volume 40, cooling system 36, generator 18, and electrical components 26. As used herein, the term “parameters” refers to physical properties whose values can be used to define the operating conditions of wind turbine 10, interior volume 40, cooling system 36, generator 18, and electrical components 26, such as a temperature, a generator torque, a power output, and/or a fluid flowrate at defined locations.

In the exemplary embodiment, control system 60 includes at least one temperature sensor 86 coupled to electrical component 26 such as, for example, power converter 28 for sensing an operating temperature of electrical component 26 and transmitting a signal indicative of the sensed temperature to controller 82. A first power output sensor 88 is coupled to generator 18 and/or power converter 28 for sensing a power output of generator 18 and/or power converter 28 and transmitting a signal indicative of the sensed power output to controller 82. In addition, a second power output sensor 90 is coupled to fluid distribution assembly 58 for sensing a rate of power used by fluid distribution assembly 58 during operation of fluid distribution assembly 58, and transmitting a signal indicative of the sensed power usage to controller 82. Moreover, control system 60 includes a nacelle temperature sensor 92 mounted within nacelle 16 for sensing a temperature of interior volume 40, and transmitting a signal indicative of the sensed nacelle temperature to controller 82. Control system 60 also includes a fluid flow sensor 94 coupled to cooling system 36 for sensing a flowrate of cooling fluid being channeled through cooling circuit 64, and transmitting a signal indicative of the sensed cooling fluid flowrate to controller 82. In addition, control system 60 includes at least one fluid temperature sensor 96 coupled to cooling circuit 64, heat exchange assemblies 54 and 56, and/or fluid distribution assembly 58 for sensing a temperature of the cooling fluid at various locations within cooling circuit 64, and transmitting signals indicative of the sensed fluid temperatures to controller 82.

In the exemplary embodiment, control system 60 operates fluid distribution assembly 58 to channel cooling fluid to power converter 28 when a sensed temperature of power converter 28 is approximately equal to, or greater than, a predefined operating temperature. In addition, control system 60 operates fluid distribution assembly 58 to adjust a flowrate of cooling fluid being channeled to power converter 28 to adjust a rate at which the temperature of power converter 28 is reduced. Moreover, in the exemplary embodiment, control system 60 adjusts a flowrate of cooling fluid such that the sensed power converter temperature is maintained within a predefined range of operating temperatures. In addition, in the exemplary embodiment, control system 60 also operates fluid distribution assembly 58 to adjust a power usage of fluid distribution assembly 58 such that the sensed power usage is within a predefined range of power usage values.

In one embodiment, control system 60 operates fluid distribution assembly 58 when a sensed power output of power converter 28 is approximately equal to, or greater than, a predefined power output, and/or when the sensed power output is within a predefined range of power output values. In another embodiment, control system 60 operates cooling system 36 when a sensed nacelle interior volume temperature is approximately equal to, or greater than, a predefined interior temperature, and adjusts a cooling fluid flowrate to facilitate reducing an interior volume temperature.

Controller 82 includes a processor 98 and a memory device 100. Processor 98 includes any suitable programmable circuit which may include one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.” Memory device 100 includes a computer readable medium, such as, without limitation, random access memory (RAM), flash memory, a hard disk drive, a solid state drive, a diskette, a flash drive, a compact disc, a digital video disc, and/or any suitable device that enables processor 98 to store, retrieve, and/or execute instructions and/or data.

Controller 82 also includes a display 102 and a user interface 104. Display 102 may include a vacuum fluorescent display (VFD) and/or one or more light-emitting diodes (LED). Additionally or alternatively, display 102 may include, without limitation, a liquid crystal display (LCD), a cathode ray tube (CRT), a plasma display, and/or any suitable visual output device capable of displaying graphical data and/or text to a user. In an exemplary embodiment, a temperature of power converter 28, a power output of generator 18, a power usage of fluid distribution assembly 58, a temperature of nacelle interior volume 40, and/or any other information may be displayed to a user on display 102. User interface 104 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into controller 82 and/or to retrieve data from controller 82. In an exemplary embodiment, the user may input a predefined temperature setting for interior volume 40, and/or power converter 28 using user interface 104. In addition, the user may input a predefined power usage setting for fluid distribution assembly 58, and/or a predefined power output range for generator 18. Moreover, the user may operate user interface 104 to initiate and/or terminate an operation of cooling system 36. Display 102 and user interface 104 may be mounted within nacelle 16, and/or at any suitable location such that display 102 and user interface 104 are accessible to a user.

In the exemplary embodiment, controller 82 includes a control interface 106 that controls an operation of cooling system 36. In some embodiments, control interface 106 is coupled to one or more control devices 108, such as, for example, fluid distribution assembly 58, first heat exchange assembly 54, and/or second heat exchange assembly 56, respectively. Controller 82 also includes a sensor interface 110 that is coupled to at least one sensor 84 such as, for example, temperature sensors 86, 92, and 96, fluid flow sensor 94, power output sensor 88, and power usage sensor 90. Each sensor 84 transmits a signal corresponding to a sensed operating parameter of wind turbine 10, cooling system 36 and/or generator 18. Each sensor 84 may transmit a signal continuously, periodically, or only once, for example, although other signal timings are also contemplated. Moreover, each sensor 84 may transmit a signal either in an analog form or in a digital form.

Various connections are available between control interface 106 and control device 108, between sensor interface 110 and sensors 84, and between processor 98 and display 102 and/or user interface 104. Such connections may include, without limitation, an electrical conductor, a low-level serial data connection, such as Recommended Standard (RS) 232 or RS-485, a high-level serial data connection, such as Universal Serial Bus (USB) or Institute of Electrical and Electronics Engineers (IEEE) 1394 (a/k/a FIREWIRE), a parallel data connection, such as IEEE 1284 or IEEE 488, a short-range wireless communication channel such as BLUETOOTH, and/or a private (e.g., inaccessible outside wind turbine 10) network connection, whether wired or wireless.

In the exemplary embodiment, during operation, when a sensed power converter temperature is approximately equal to, or greater than, a predefined operating temperature, control system 60 operates fluid distribution assembly 58 to channel cooling fluid to power converter 28 to facilitate reducing the operating temperature of power converter 28. In addition, control system 60 adjusts a flowrate of the cooling fluid being channeled to power converter 28 to maintain the power converter temperature at, or below, the predefined operating temperature. If the operating temperature increases above the predefined temperature, control system 60 increases the flowrate of cooling fluid to facilitate reducing the operating temperature. As the operating temperature decreases, control system 60 reduces the flowrate of cooling fluid to maintain the operating temperature at, or below, the predefined operating temperature.

In one embodiment, control system 60 calculates a cooling cycle to reduce the sensed component temperature to a predefined component temperature. The calculated cooling cycle includes operating fluid distribution assembly 58 at a cooling fluid flowrate for a period of time to reduce the sensed component temperature to the predefined component temperature. The control system 60 also calculates a power consumption associated with the calculated cooling cycle and adjusts the cooling fluid flowrate and/or the cooling fluid cycle period based on the calculated power output such that the power consumption of fluid distribution assembly 58 does not exceed a predefined power consumption value.

In another embodiment, control system 60 calculates a plurality of cooling cycles including a plurality of flowrates and a plurality of associated time periods. Control system 60 also calculates a plurality of power consumption values associated with each calculated cooling cycle. In addition, control system 60 calculates a health value of power converter 28 associated with each of a plurality of operating temperatures, and a period of time at which power converter 28 is operated at an associated temperature. Control system 60 also applies one or more weighting factors to each calculated power consumption value and/or each calculated health value. Control system 60 calculates an operating cooling cycle based at least in part on the weighted power consumption value and the weighted health value, and operates fluid distribution assembly 58 at the calculated operating cooling cycle to reduce the sensed component temperature to the predefined component temperature.

By operating fluid distribution assembly 58 at varying flowrates, an operating temperature of power converter 28 is maintained within a predefined range of operating temperatures, and a power usage of cooling system 36 can be optimized.

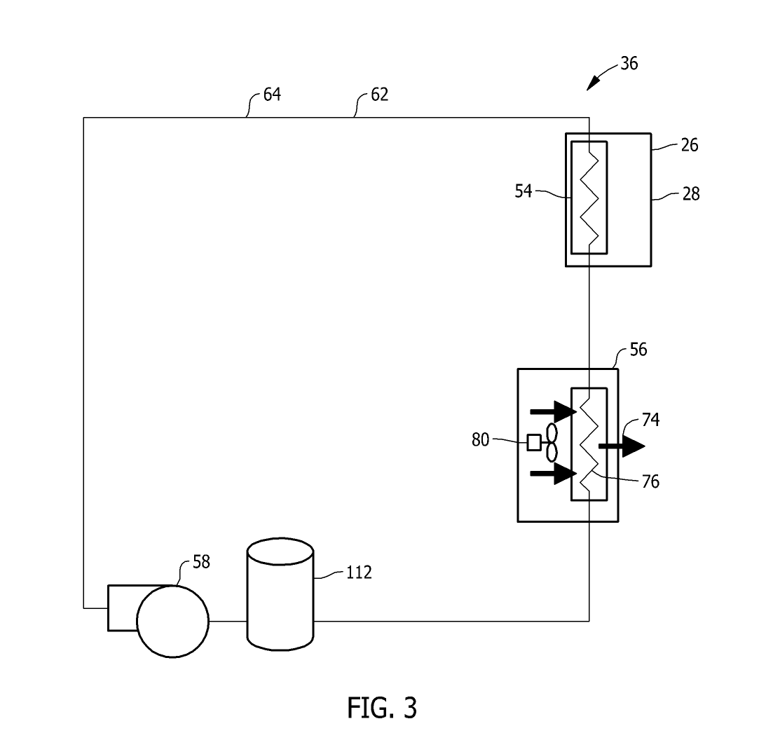

FIGS. 3-5 are sectional views of alternative embodiments of cooling system 36. Identical components shown in FIGS. 3-5 are labeled with the same reference numbers used in FIG. 2. Referring to FIG. 3, in an alternative embodiment, cooling system 36 includes a reservoir 112 that is coupled in flow communication with first heat exchange assembly 54, second heat exchange assembly 56, and fluid distribution assembly 58. Reservoir 112 facilitates accommodating a thermal expansion of cooling fluid being channeled through cooling circuit 64 to regulate a fluid pressure within cooling circuit 64. In one embodiment, reservoir 112 is vented to atmosphere.

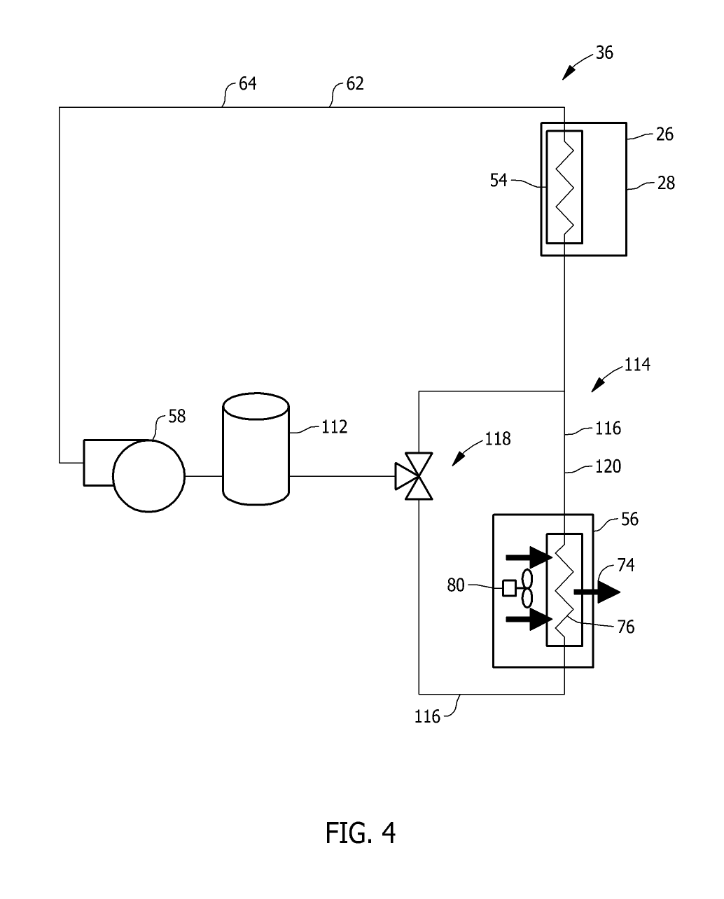

Referring to FIG. 4, in another embodiment, cooling system 36 includes a temperature regulator assembly 114 that is coupled in flow communication with fluid distribution assembly 58 and second heat exchange assembly 56 to adjust a temperature of cooling fluid channeled between second heat exchange assembly 56 and fluid distribution assembly 58. Temperature regulator assembly 114 includes a plurality of fluid lines 116 coupled between a valve assembly 118 and second heat exchange assembly 56 to form a second cooling circuit 120. Valve assembly 118 is movable between a first position (not shown) to enable cooling fluid to be channeled from second heat exchange assembly 56 to fluid distribution assembly 58, and a second position (not shown) to enable cooling fluid to be re-circulated through second cooling circuit 120 and through second heat exchange assembly 56 to facilitate reducing a temperature of the cooling fluid. Control system 60 is coupled to valve assembly 118 to operate valve assembly 118 to selectively channel cooling fluid from second heat exchange assembly 56 to fluid distribution assembly 58 based at least in part on the sensed cooling fluid temperature.

Referring to FIG. 5, in one embodiment, cooling system 36 includes a vapor compression cycle system 122. Vapor compression cycle system 122 includes fluid distribution assembly 58, i.e. a compressor 70, first heat exchange assembly 54, i.e. an evaporator 124, second heat exchange assembly 56, i.e. a condenser 126, and expansion valve 128, that are each coupled in series. Evaporator 124 transfers heat from power converter 28 to a refrigerant flowing through vapor compression cycle system 122, thereby causing the refrigerant to vaporize. Compressor 70 receives the heated vapor from evaporator 124, compresses the heated vapor and channels the compressed vapor to condenser 126. Condenser 126 transfers heat from the heated vapor to ambient air to cool the vapor and form a condensed liquid refrigerant. The condensed liquid refrigerant is channeled through expansion valve 128 to reduce a pressure of the refrigerant and to reduce the refrigerant temperature. The cooled refrigerant is then channeled to evaporator 124 to facilitate cooling power converter 28.

In the exemplary embodiment, condenser 126 is a variable speed condenser. Control system 60 (shown in FIG. 2) is coupled to condenser 126 to adjust a flowrate of refrigerant being channeled through evaporator 124 to adjust a temperature of power converter 28. In one embodiment, evaporator 124 includes a plurality of chiller plates 66 that are coupled to a plurality of electrical components 26 such as, for example, a plurality of power converters 28.

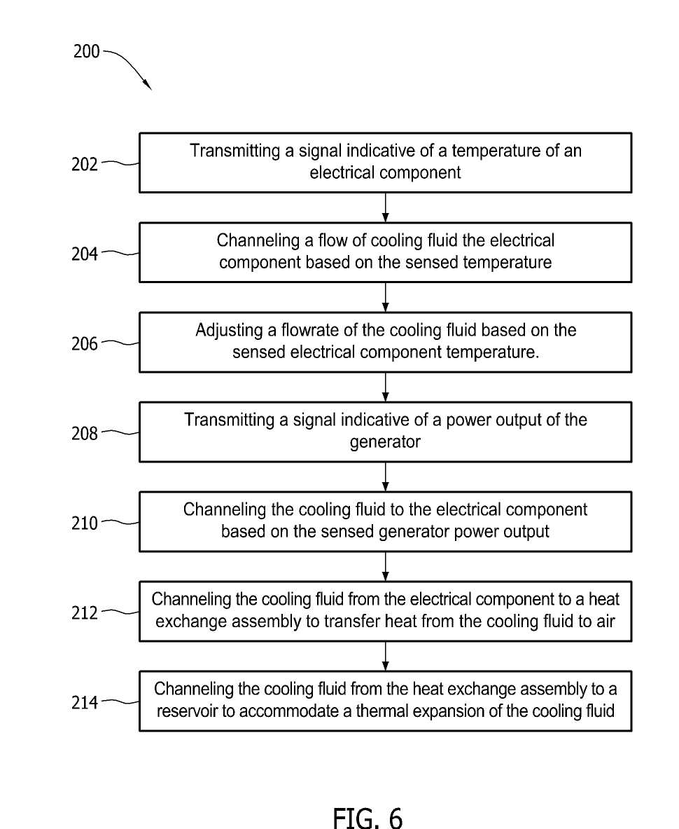

FIG. 6 is a flow chart of a method 200 for use in adjusting a temperature of electrical components 26 of wind turbine 10. In the exemplary embodiment, method 200 includes transmitting 202, from sensor 84 to controller 82, a signal indicative of a temperature of electrical component 26, and channeling 204 a flow of cooling fluid from fluid distribution assembly 58 to first heat exchange assembly 54 based at least in part on the sensed electrical component temperature. Method 200 also includes adjusting 206 a flowrate of the cooling fluid channeled from fluid distribution assembly 58 to electrical component 26 based at least in part on the sensed electrical component temperature. In addition, a signal indicative of a power output of generator 18 is transmitted 208, and a flow of cooling fluid is channeled 210 from fluid distribution assembly 58 to electrical component 26 based at least in part on the sensed generator power output. Method 200 also includes channeling 212 the cooling fluid from electrical component 26 to second heat exchange assembly 56 to transfer heat from the cooling fluid to air channeled across the cooling fluid. In addition, method 200 includes channeling 214 the cooling fluid from second heat exchange assembly 56 to reservoir 112 to accommodate a thermal expansion of the cooling fluid.

An exemplary technical effect of the methods, system, and apparatus described herein includes at least one of: (a) transmitting, from a sensor to a controller, a signal indicative of a temperature of an electrical component; (b) channeling a flow of cooling fluid from a fluid distribution assembly to a first heat exchange assembly coupled to the electrical component based at least in part on the sensed electrical component temperature to facilitate reducing a temperature of the electrical component; and, (c) adjusting a flowrate of the cooling fluid channeled from the fluid distribution assembly to the electrical component based at least in part on the sensed electrical component temperature.

The above-described systems and methods overcome at least some disadvantages of known cooling systems by providing a cooling system that includes a variable speed fluid distribution assembly to facilitate cooling electrical components of wind turbines. More specifically, the cooling system described herein includes a fluid distribution assembly that is configured to adjust a flowrate of cooling fluid being channeled to the electrical components to maintain an operating temperature of the electrical components within a predefined range of operating temperature. In addition, by operating the cooling system to adjust the flowrate of cooling fluid, the power consumption of the cooling system can be optimized. As such, the duration and frequency of operating the cooling system is facilitated to be reduced, thus reducing the cost of cooling the wind turbine electrical components.

Exemplary embodiments of systems and methods for cooling electrical components of wind turbines are described above in detail. The systems and methods are not limited to the specific embodiments described herein, but rather, components of the systems and/or steps of the methods may be utilized independently and separately from other components and/or steps described herein. For example, the methods may also be used in combination with other wind turbines, and are not limited to practice with only the wind turbine as described herein. Rather, the exemplary embodiment can be implemented and utilized in connection with many other cooling system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cooling system for use in cooling an electrical component of a wind turbine, said cooling system comprising:
a first heat exchange assembly coupled to the electrical component, said first heat exchange assembly configured to transfer heat from the electrical component to a cooling fluid; and,
a fluid distribution assembly coupled to said first heat exchange assembly for selectively channeling cooling fluid to said first heat exchange assembly, said fluid distribution assembly configured to adjust a flowrate of the cooling fluid being channeled to said first heat exchange assembly to adjust a temperature of the component.

2. A cooling system in accordance with claim 1, wherein said fluid distribution assembly is configured to adjust a flowrate of the cooling fluid to selectively adjusting a power consumption of said fluid distribution assembly.

3. A cooling system in accordance with claim 1, further comprising a second heat exchange assembly coupled to said fluid distribution assembly and said first heat exchange assembly, said second heat exchange assembly configured to channel a flow of air across the cooling fluid to facilitate transferring heat from the cooling fluid to the air to reduce a temperature of the cooling fluid.

4. A cooling system in accordance with claim 3, wherein the wind turbine includes a nacelle that includes an inner surface that defines an interior volume therein, and wherein the electrical component is positioned within the nacelle, said second heat exchange assembly is positioned external to the nacelle.

5. A cooling system in accordance with claim 3, further comprising a reservoir coupled in flow communication with said fluid distribution assembly to accommodate thermal expansion of the cooling fluid channeled from said first heat exchange assembly to said fluid distribution assembly.

6. A cooling system in accordance with claim 3, further comprising a temperature regulator assembly coupled between said fluid distribution assembly and said second heat exchange assembly for adjusting a temperature of cooling fluid channeled between said second heat exchange assembly and said fluid distribution assembly.

7. A cooling system in accordance with claim 3, wherein said fluid distribution assembly includes a variable speed fluid pump.

8. A cooling system in accordance with claim 1, wherein said fluid distribution assembly includes a variable speed compressor.

9. A cooling system in accordance with claim 1, further comprising a control system coupled to said fluid distribution assembly, said control system configured to adjust a flowrate of cooling fluid channeled from said fluid distribution assembly to said first heat exchange assembly to facilitate reducing a temperature of the electrical component, and selectively adjust a power consumption of said fluid distribution assembly.

10. A wind turbine, comprising:
a nacelle;
a generator positioned within said nacelle; and,
a cooling system coupled to an electrical component of said generator for adjusting a temperature of the electrical component, said cooling system comprising:
a first heat exchange assembly coupled to the electrical component, said first heat exchange assembly configured to transfer heat from the electrical component to a cooling fluid; and,
a fluid distribution assembly coupled to said first heat exchange assembly for selectively channeling cooling fluid to said first heat exchange assembly, said fluid distribution assembly configured to selectively adjust a flowrate of the cooling fluid to adjust a temperature of said electrical component.

11. A wind turbine in accordance with claim 10, further comprising a second heat exchange assembly coupled to said fluid distribution assembly and said first heat exchange assembly, said second heat exchange assembly configured to channel a flow of air across the cooling fluid to facilitate transferring heat from the cooling fluid to the air to reduce a temperature of the cooling fluid.

12. A wind turbine in accordance with claim 11, wherein the wind turbine includes a nacelle that includes an inner surface that defines an interior volume therein, and wherein the electrical component is positioned within the nacelle, said second heat exchange assembly is positioned external to the nacelle.

13. A wind turbine in accordance with claim 11, further comprising a reservoir coupled in flow communication with fluid distribution assembly to accommodate thermal expansion of the cooling fluid channeled from said first heat exchange assembly to said fluid distribution assembly.

14. A wind turbine in accordance with claim 11, further comprising a temperature regulator assembly coupled between said fluid distribution assembly and said second heat exchange assembly for adjusting a temperature of cooling fluid channeled between said second heat exchange assembly and said fluid distribution assembly.

15. A wind turbine in accordance with claim 11, wherein said fluid distribution assembly includes a variable speed fluid pump.

16. A wind turbine in accordance with claim 10, wherein said fluid distribution assembly includes a variable speed compressor.

17. A wind turbine in accordance with claim 10, further comprising a control system coupled to said fluid distribution assembly, said control system configured to adjust a flowrate of cooling fluid channeled from said fluid distribution assembly to said first heat exchange assembly to facilitate reducing a temperature of the electrical component, and selectively adjust a power consumption of said fluid distribution assembly.

18. A method of adjusting a temperature of an electrical component of a wind turbine, said method comprising:
transmitting, from a sensor to a controller, a signal indicative of a temperature of an electrical component;
channeling a flow of cooling fluid from a fluid distribution assembly to a first heat exchange assembly coupled to the electrical component based at least in part on the sensed electrical component temperature to facilitate reducing a temperature of the electrical component; and,
adjusting a flowrate of the cooling fluid channeled from the fluid distribution assembly to the electrical component based at least in part on the sensed electrical component temperature.

19. A method in accordance with claim 18, further comprising;
transmitting a signal indicative of a power output of the generator; and,
channeling a flow of cooling fluid from the fluid distribution assembly to the electrical component based at least in part on the sensed generator power output.

20. A method in accordance with claim 18, further comprising channeling the cooling fluid from the electrical component to a second heat exchange assembly to transfer heat from the cooling fluid to air channeled across the cooling fluid.
